(19) United States
(12) Patent Application Publication
(10) Pub. No.: US 2025/0067687 A1
(43) Pub. Date: Feb. 27, 2025

(54) METHOD AND SYSTEM FOR CALIBRATING DETECTORS IN A DETECTOR ARRAY

(71) Applicants: Thermo EGS Gauging LLC, Wilmington, DE (US); Thermo Ramsey LLC, Minneapolis, MN (US); Thermo ONIX Limited, Winsford (GB)

(72) Inventors: Carter Watson, Nashua, NH (US); Sergey Moskalenko, Maple Grove, MN (US); Paul Kelly, Dursley (GB)

(21) Appl. No.: 18/813,223

(22) Filed: Aug. 23, 2024

Related U.S. Application Data
(60) Provisional application No. 63/578,407, filed on Aug. 24, 2023.

(51) Int. Cl. G01N 23/083

(52) U.S. Cl. CPC G01N 23/083; G01N 2223/303; G01N 2223/501

(57) ABSTRACT

A calibration method for a gauging instrument is described. The method includes positioning n samples having a known basis weight, between a source and a detector array comprised of m detectors linearly oriented in a first direction. The n samples are scanned by; (a) irradiating each of the n samples with x-rays from the source, (b) stepping each of the n samples in the first direction in a step that is smaller than the spatial resolution of the detectors, and (c) irradiating each of the n samples with x-rays from the source. Groups of signals are generated corresponding to each of the detectors. A calibration curve is established for each detector by fitting the known basis weights for each of the n samples to the group of m signals, wherein n is a positive integer greater than 0 and m is positive integer greater than 1.

### CROSS-REFERENCE TO RELATED APPLICATIONS

This application claims the benefit under 35 U.S.C. § 119(e) of U.S. Provisional Application No. 63/578,407 filed Aug. 24, 2023. The entire content of the aforementioned application are incorporated by reference herein.

### FIELD OF THE INVENTION

This invention is directed to detector arrays. In particular, methods and systems for calibrating detectors in a detector array of a gauging instrument.

### BACKGROUND OF THE INVENTION

In gauging systems, such as x-ray or IR systems, or x-ray screening systems, such as for parcels, freight, or mail, a detector array can be arranged under a screening area or space and a beam from a source can be directed through the screening area and to the detectors in the detector array. This allows quantitative or qualitative measurement by detecting the decrease in transmission through an object in the screening area. Especially in the case of quantitative measurements, an appropriate calibration curve is used. Since each detector in the detector array responds slightly differently to the x-ray radiation, each detector is individually calibrated to ensure accuracy and precision.

A challenge with such systems is ensuring that each detector in the detector array is properly calibrated. A detector in an array might detect an imperfection, such as a thicker area than the average, that is in one portion of a sample, and an adjacent detector in the array may not be positioned to “see” this imperfection. Such imperfections can cause inaccuracies in the calibration data and increase errors in the measurement results relying on the calibrations.

There is therefore an unmet need for highly accurate calibrations of detectors in a detector arrays.

### SUMMARY

Systems, methods, and products to address these and other needs are described herein with respect to illustrative, non-limiting, implementations. Various alternatives, modifications and equivalents are possible.

According to a first aspect a calibration method for a gauging instrument is described. The method includes positioning in a first position, and one at a time, n samples each having a known basis weight, said first position is between a source and a detector array comprised of m detectors linearly oriented in a first direction. The n samples are scanned by; (a) irradiating each of the n samples with x-rays from the source, (b) stepping each of the n samples in the first direction in a step that is smaller than the spatial resolution of the detectors, and (c) irradiating each of the n samples with x-rays from the source. m groups of signals are generated, each group corresponding to one of the m detectors 108, and each signal proportional to x-rays transmitted through each of the n samples and impinging on one of the m detectors during the scanning. A calibration curve is established for each detector by fitting the known basis weights for each of the n samples to the group of m signals, wherein n is a positive integer greater than 0 and m is positive integer greater than 1.

According to a second aspect a system for calibration of a gauging instrument is described. The system includes: an x-ray source; a detector array comprised of m detectors linearly oriented in a first direction; a space between the source and the detector array; a sample holder; and a computing device having executable code stored thereon. The executable code is configured to send instruction for one or more of the method steps described according to the first aspect.

According to a third aspect, a one or more non-transitory computer readable media having instructions thereon is described. The instructions, when executed by one or more processing devices of a gauging instrument support apparatus, cause the gauging instrument support apparatus to perform the method according to the first aspect.

The methods, systems and non-transitory media fulfill an unmet need of calibrating of detectors in a detector arrays.

### BRIEF DESCRIPTION OF THE DRAWINGS

The foregoing and other features and advantages of the present embodiments will be more fully understood from the following detailed description of illustrative embodiments taken in conjunction with the accompanying drawings.

FIGS. 1A and 1B show a gauging or screening instrument, according to some implementations.

FIGS. 1C and 1D show the gauging instrument of FIGS. 1A and 1B with a sample holder that can be included according to some implementations.

FIG. 2 illustrates a method for calibrating a gauging instrument, according to some implementations.

FIG. 3 illustrates a scanning procedure, according to some implementations.

FIG. 4 is a flow diagram showing the steps illustrated by FIGS. 2 and 3.

FIG. 5 is a block diagram of the computing device that may perform some or all of the method steps described herein, according to some implementations.

FIG. 6 is a block diagram of an example scientific instrument support system in which some or all the methods disclosed herein may be performed, in accordance with various implementations.

FIG. 7 is a block diagram of a system for checking a gauge response, according to some implementations.

The figures referred to above are not drawn necessarily to scale, should be understood to provide a representation of particular embodiments, and are merely conceptual in nature and illustrative of the principals involved. The same reference numbers are used in the drawings for similar or identical components and features shown in various alternative embodiments.

### DETAILED DESCRIPTION

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the statistical dispersion found in their respective testing measurements.

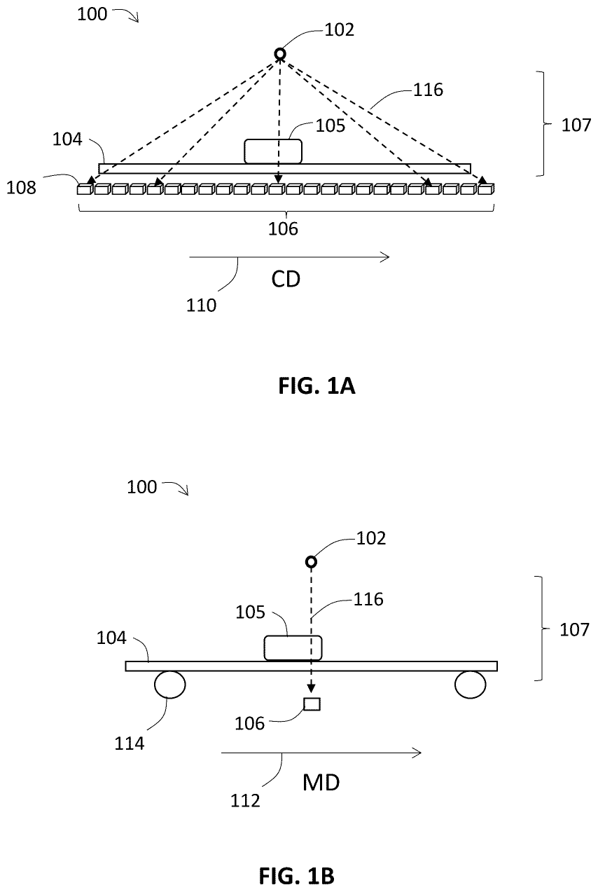

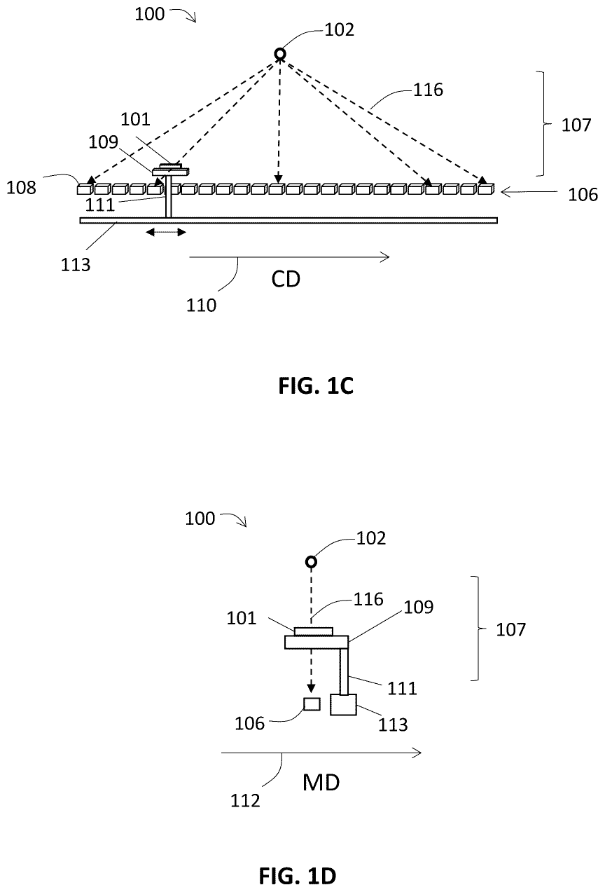

FIGS. 1A and 1B show a gauging or screening instrument 100, according to some implementations. The gauging instrument 100 includes a radiation source 102, a web 104, and a detector array 106. FIG. 1A shows a front view and FIG. 1B shows a side view. The detector array 106 includes m detectors 108, where m is a positive integer greater than 1. The detectors 108 are linearly oriented in a first direction 110, which corresponds to the Cross Direction (CD). The web 104 travels in a second direction 112, which corresponds to the Machine Direction (MD) and can be supported by translation elements 114. The radiation source 102 is depicted as a point source which provides radiation 116 as a fan-beam which strikes the detector array 106 after passing through the web 104. The web 104 itself can be the object under investigation, such as a thin film or laminate, or an item 105 can be place on the web 104 (e.g., a conveyor belt) where the item 105 is passed through a space 107 between the radiation source 102 and the array.

FIGS. 1C and 1D show the gauging instrument 100 with a sample holder 109 that can be included in some implementations. FIG. 1C is a front view and FIG. 1D is a side view. The sample holder 109 can move in the first direction 110 to move the holder 109 in the radiation 116 in the space 107. In some implementations, the sample holder 109 can also move in the second direction 112, so that the sample holder 109 acts as an “xy” stage. The sample holder 109 can be connected by an arm 111 to a rail 113 to move the sample holder 109 in the first direction 110. The rail 113 can be longer than the detector array 106 in the first direction 110 so that the sample holder 109 can be moved out of the radiation 116. The sample holder 109 can also include other or alternative elements such as rails, actuators, and screws, and motors, to move the sample holder 109 in the second direction 112. In some implementations, the sample holder 109 also includes elements to move the holder in a third direction that is perpendicular to the first direction 110 and the second direction 112.

In some implementations, the sample holder 109 can accommodate more than one sample 101 at a time. For example, the sample holder 109 can accommodate a plurality the samples 101 next to each other on the sample holder 109 so that each can be positioned between the radiation 116 and the detectors 108, where the samples 101 do not overlap. In some other implementations, the samples 109 can be stacked (overlapped) so that the radiation 116 passes through the stacked sample 109 before reaching the detectors 108.

The n sample can be positioned anywhere between the detector array 106 and the source 102. Positioning the samples 101 closer to the source 102 provides a magnification of imaging, the closer to the source the sample is positioned. For example, placing a sample ¼ the distance from the source to the detector array in a fan beam having a 90-degree angle provides a 3-fold magnification. However, blurring also occurs the further the sample is to the detectors 108. In addition, attenuation of x-rays after passing through the sample 108 by air between the detectors 108 and the samples 101 can distort/harden the beam. In some implementations, the n samples are positioned proximate to the linear array of detectors and distal from the source. For example, the samples 101 are positioned ¼ the distance, or less, from the detectors 108 to the source. In some implementations the samples 101 are placed less than 5 mm from the detector array.

It is appreciated that a scanning beam that rasters in the CD direction can also be used, or multiple fan-beams that span the detector array 106 can be used. Additionally, more than one row of detectors 108 can be used for the detector array 106, such as two or more adjacent rows arrays oriented in the MD direction. In some implementations, the radiation source 102 is an x-ray source.

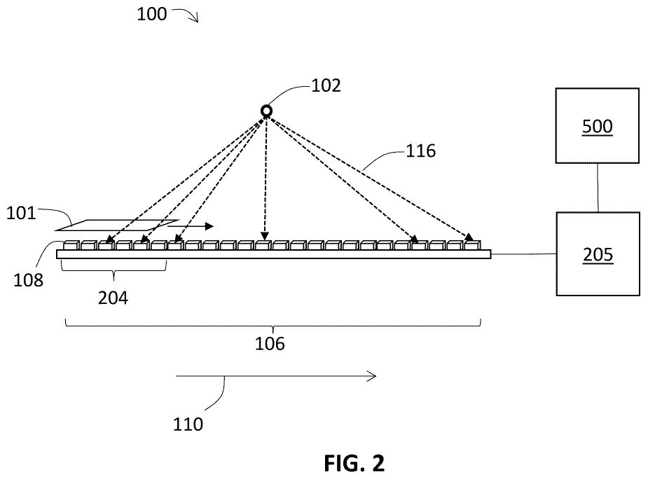

FIG. 2 illustrates a method for calibrating a gauging instrument 100, according to some implementations. Using the gauging instrument 100, the sample 101 is positioned in a first position 204 between the source 102 and the detector array 106, which includes the m detectors 108 linearly orient in the first direction 110. The sample 101 has a known basis weight or thickness. The sample 101 casts a shadow on a subset of the detectors 108 under first position 204 in that it blocks some of the radiation 116 from reaching the detectors 108 under first position 204. In some implementations, the sample 101 can be placed in the sample holder 109 (FIGS. 1C and 1D).

The sample 101 is scanned by stepping the sample 101 in the first direction 110 in a step size that is smaller than the spatial resolution of the detectors 108 and stopping after each step and irradiating the sample 101 with x-rays from the source 102. In some implementations, the sample 101 is continuously irradiated, even when the sample 101 is being moved during the stepping. This scanning generates m groups of signals each proportional to x-rays 116 transmitted through the sample 101 and impinging on one of the m detectors 108 during each step. A calibration curve is established for each of the detectors 108 by fitting the known basis weight of the sample 101 and the corresponding signals for each of the m detectors 108.

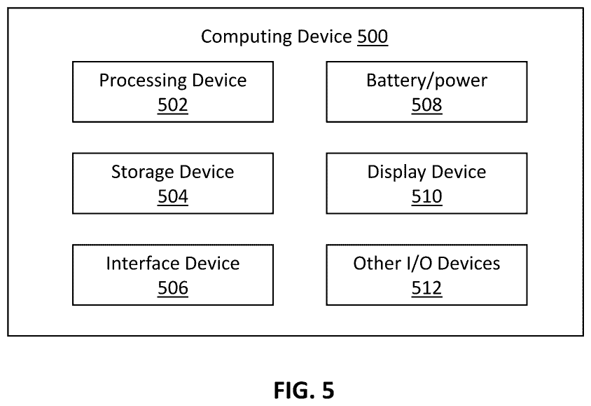

The detectors 108 include, or are in communication with, electric circuits 205 to accept as input initial signals generated from the interaction of the radiation 116 with the detectors 108. These initial signals are amplified and digitized by the electric circuits 205 and output as the sample signals which are used in constructing calibration curves of the detectors 108. In some implementations, the sample signals are sent/input to a computing device 500 (which will be described in more detail below with reference to FIG. 5).

One or more samples 101 can be scanned. For, example, n samples 101 can be used, where n is a positive integer greater than zero. The samples 101 can have different known basis weights or thicknesses. Therefore, each calibration curve will include at least n data points, and can also include dark (no x-ray transmission) and bright (maximum x-ray transmission) data used to construct calibration curves. In other words, each calibration curve corresponds to one of the m group of signals, where if n samples are used, each of the m groups of signals can have at least n signals. Any number of samples 101 can be used, depending on the desired accuracy of the calibration curve. In some implementations 2 or 3 samples 101 are used. In some implementations up to 25 samples 101 are used.

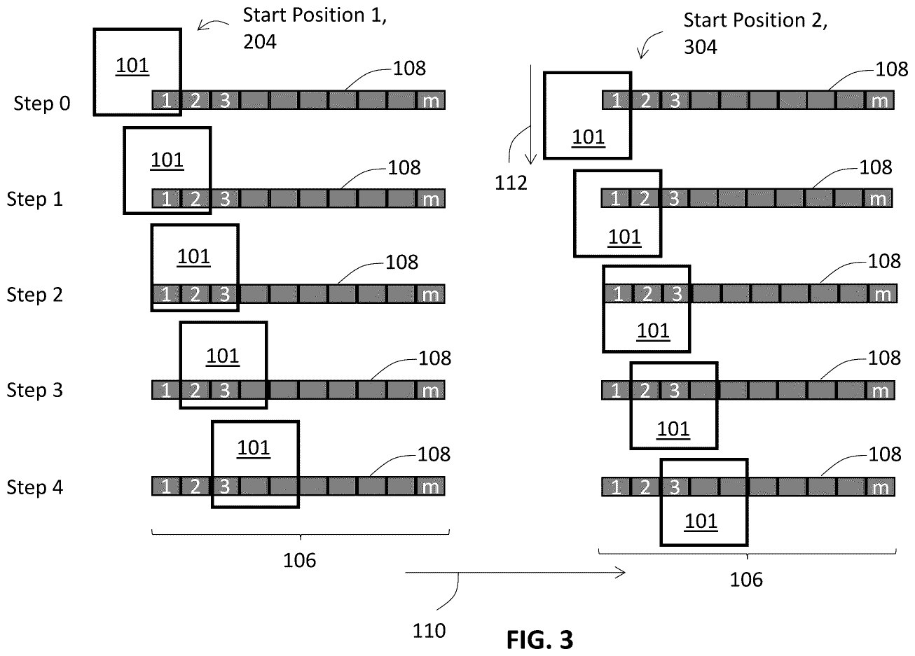

FIG. 3 illustrates the scanning steps or procedure, according to some implementations. The sample 101 is shown in a transparent view above the detector array 108. From top to bottom in the figure, the sample 101 in positions for each scanning step 0 to 4 is shown, where scanning step 0 positions the sample 101 in the first position. While the sample 101 is in the first position, the sample 101 is irradiated and x-rays passing through the sample 101 strike the left most detector 108-1 in the detector array 108 thereby generating a signal. The sample is then moved in the first direction 110 from the first position 204 in the first step, and signals are generated by detectors 108-1 and 108-2 by x-rays passing through the sample 101. The sample is then moved in a second step, where sample 101 covers detectors 108-1, 108-2, and 108-3. Steps 3, 4 etc. . . . can be taken until all the detectors 108 in the detector array 106 have collected signals corresponding to x-rays passing through the sample 101. This way each detector generates a group of signals associated with the sample 101. A second and third sample can be then scanned in a similar fashion providing new signals corresponding to the second and third sample and grouped by the detectors 108. In some implementations, the sample 101 can be positioned in a second position 304, where the second position 304 is offset in the second direction 112. Any distance in the second direction 112 can be taken to position the sample 101 in the second position. In some implementations, additional starting positions, such as a third, fourth or fifth position, can be used, where each additional starting position is offset from the preceding position in the second direction 112. In this way, the entire area of the sample 101 can be scanned, with the resolution depending in part on the step size and the starting positions. In some implementation, the sample 101 can be translated in the first direction 110 from the second position 304 and any subsequent starting positions. It is also noted that the scanning steps do not need to be in the order depicted i.e., steps 0 to 4 which translate the sample 101 from the left most detector 108-1 to the rightmost detector 108-m. In some implementations the starting position can be any position placing the sample 101 above the array so that the sample 101 is between at least one detector 108 and the source 102. For example, a first position can be the position depicted in Step 2, left side, of FIG. 3, and the sample 101 can be moved to the other positions such as those shown for step 0, step 4, step m etc. . . . in a random order, until all steps are taken.

Table 1 illustrates data collected by method depicted in FIG. 3 with n samples 101 and a detector array 106 of m detectors 108. Groups 1 to m are listed as column headers with samples 1-n listed as subheadings for each of the groups. Starting positions are shown as row headings (e.g., first position 204 and second position 304) with Steps 1 to m shown as subheadings for each of the starting positions. Each group corresponds to a detector 108 and includes signals (denoted x in the table) from each n sample 101. It is also noted that each sample 101 will contribute a number of signals that depends on the step size and the size of the shadow cast by the sample 101 on the detectors 108. Using the step sizes and sample 101 depicted by FIG. 3, this gives 3 signals per sample 101. Smaller step sizes will provide more signals per sample 101, while larger step sizes will provide less signals per sample 101.

To further clarify this implementation, the progress of sample 1 is outlined. After step 0 the sample 1 only provides x-rays (giving rise to the signal x shown in Table 1) to detector 1, which is in group 1, where detector 2 (in group 2), detector 3 (group 3), up to detector m (group m) do not receive x-rays passing through the sample 1. The sample is then moved in step 1 after which the sample 1 provides x-rays to detector 1 (group 1) and detector 2 (group 2) (giving rise to the signal x shown in table 1 under group 1-sample 1, and group 2-sample 1), where detector 3 (group 3), up to detector m (group m) do not receive x-rays passing through the sample 1. The sample is then moved in step 2 after which the sample 1 provides x-rays to detector 1 (group 1), detector 2 (group 2), and detector 3 (group 3) (giving rise to the signal x shown in table 1 under group 1-sample 1, group 2-sample 1, and group 3 sample-1), where the rest of the detectors up to m do not received x-rays passing through the sample 1. This is repeated to step m. In the antepenultimate step m−2, detector m−2 (group m−2), detector m−1 (group m−1) and detector m (group m) receive x-rays that pass through sample 1, while the rest of the detectors 1 to m−2 do not received x-rays passing through the sample 1. In the penultimate step m−1, detector m−1 (group m−1) and detector m (group m) receive x-rays that pass through sample 1, while all the detectors from 1 to m−2 do not received x-rays passing through the sample 1. In the last step m that is represented in the table, only the m detector (group m) receives x-rays that pass through the sample 1. It is understood that all the detectors a received x-rays during this procedure, and provide signals, however the signals denoted by x only correspond to x-rays passing through a sample such as sample 1.

The step size should not be larger than the detector 108 pitch in order to collect at least one signal from each sample. As used here, the pitch is the width of the detector 108 in the first direction 110. Smaller step sizes can provide more signals, but if the amount of time to collect data is the same for each step, the data collection time is increased. At one extreme, the step sizes can be infinitely small, where the scanning is a continuous movement. In some implementations, the step is less than or equal to half of the spatial resolution of the detectors 108. The spatial resolution is the pitch of the detector. In some implementations, the step size is less than or equal to 5 mm (e.g., less than or equal to 2 mm, less than or equal to 1 mm).

In some implementations, the sample is irradiated for the same amount of time after each step (and before a subsequent step) and when the sample 101 is in the starting first position 204 and starting second position 304. For example, the sample is irradiated after each step for a fixed time selected between 1 ms and 5 seconds (e.g., 10 ms to 100 ms) before a subsequent step. In some implementations, the x-rays are continuously being generated from the source 102 (FIG. 2) while collecting data and radiation 116 continuously strikes the detector array 106, but signals collected only during the fixed time are processed and used for generating the calibrations. In some other implementations, the radiation 116 does not continuously strike the detector array 106 during data collection, such as the source 102 being blocked by a shutter during the steps and in the time between the fixed time (e.g., during stepping). The fixed time can also account for a settling time. For example, the stepping and movement can cause minor vibrations to the sample 101 which would increase the noise of the signal. Such vibrations can be mitigated by allowing some time for the sample to settle in the new position after each step.

In some implementations, each of the n samples 101 is positioned in a second position 304 that is offset in the second direction 112. This will increase the number of signals for each sample 101.

TABLE 1

| Position 2 | | | | | | | | | | Position 1 | | | | | | | | | | | | |
|---|---|---|---|---|---|---|---|---|---|---|---|---|---|---|---|---|---|---|---|---|---|---|
| m [symbol] | m [symbol] | m [symbol] | | | 4 | 3 | 2 | 1 | 0 | m [symbol] | m [symbol] | m [symbol] | | | 4 | 3 | 2 | 1 | 0 | St [symbol] | S [symbol] | |
| | | | | | | | [symbol] | [symbol] | [symbol] | | | | | | | | [symbol] | [symbol] | [symbol] | | 1 | Group 1 |
| | | | | | | | [symbol] | [symbol] | [symbol] | | | | | | | | [symbol] | [symbol] | [symbol] | | 2 | |
| | | | | | | | [symbol] | [symbol] | [symbol] | | | | | | | | [symbol] | [symbol] | [symbol] | | 3 | |
| | | | | | | | [symbol] | [symbol] | [symbol] | | | | | | | | [symbol] | [symbol] | [symbol] | | | |
| | | | | | | | [symbol] | [symbol] | [symbol] | | | | | | | | [symbol] | [symbol] | [symbol] | [symbol] | | |
| | | | | | | [symbol] | [symbol] | [symbol] | | | | | | | | [symbol] | [symbol] | [symbol] | | | 1 | Group 2 |
| | | | | | | [symbol] | [symbol] | [symbol] | | | | | | | | [symbol] | [symbol] | [symbol] | | | 2 | |
| | | | | | | [symbol] | [symbol] | [symbol] | | | | | | | | [symbol] | [symbol] | [symbol] | | | 3 | |
| | | | | | | [symbol] | [symbol] | [symbol] | | | | | | | | [symbol] | [symbol] | [symbol] | | | | |
| | | | | | | [symbol] | [symbol] | [symbol] | | | | | | | | [symbol] | [symbol] | [symbol] | | [symbol] | | |
| | | | | | x | x | x | | | | | | | | x | x | x | | | | 1 | Group 3 |
| | | | | | [symbol] | [symbol] | [symbol] | | | | | | | | [symbol] | [symbol] | [symbol] | | | | 2 | |
| | | | | | [symbol] | [symbol] | [symbol] | | | | | | | | [symbol] | [symbol] | [symbol] | | | | 3 | |
| | | | | | | | | | | | | | | | [symbol] | [symbol] | [symbol] | | | | | |
| | | | | | | | | | | | | | | | [symbol] | [symbol] | [symbol] | | | [symbol] | | |
| | | | | | | | | | | | | | | | | | | | | | | . . . |
| | | x | x | x | | | | | | | | x | x | x | | | | | | | 1 | Group |
| | | [symbol] | [symbol] | [symbol] | | | | | | | | [symbol] | [symbol] | [symbol] | | | | | | | | m-2 |
| | | [symbol] | [symbol] | [symbol] | | | | | | | | [symbol] | [symbol] | [symbol] | | | | | | [symbol] | | |
| | | [symbol] | [symbol] | [symbol] | | | | | | | | [symbol] | [symbol] | [symbol] | | | | | | [symbol] | | |
| | | [symbol] | [symbol] | [symbol] | | | | | | | | [symbol] | [symbol] | [symbol] | | | | | | [symbol] | | |
| | | x | x | | | | | | | | x | x | x | | | | | | | | 1 | Group |
| | | [symbol] | [symbol] | | | | | | | | [symbol] | [symbol] | [symbol] | | | | | | | | | m-1 |
| | [symbol] | [symbol] | [symbol] | | | | | | | | [symbol] | [symbol] | [symbol] | | | | | | | [symbol] | | |
| | [symbol] | [symbol] | [symbol] | | | | | | | | [symbol] | [symbol] | [symbol] | | | | | | | [symbol] | | |
| | [symbol] | [symbol] | [symbol] | | | | | | | | [symbol] | [symbol] | [symbol] | | | | | | | [symbol] | | |
| | x | x | | | | | | | | x | x | x | | | | | | | | | 1 | Group |
| | [symbol] | [symbol] | | | | | | | | [symbol] | [symbol] | [symbol] | | | | | | | | | | m |
| [symbol] | [symbol] | [symbol] | | | | | | | | [symbol] | [symbol] | [symbol] | | | | | | | | [symbol] | | |
| [symbol] | [symbol] | [symbol] | | | | | | | | [symbol] | [symbol] | [symbol] | | | | | | | | [symbol] | | |
| [symbol] | [symbol] | [symbol] | | | | | | | | [symbol] | [symbol] | [symbol] | | | | | | | | [symbol] | | |

[symbol]

indicates data missing or illegible when filed

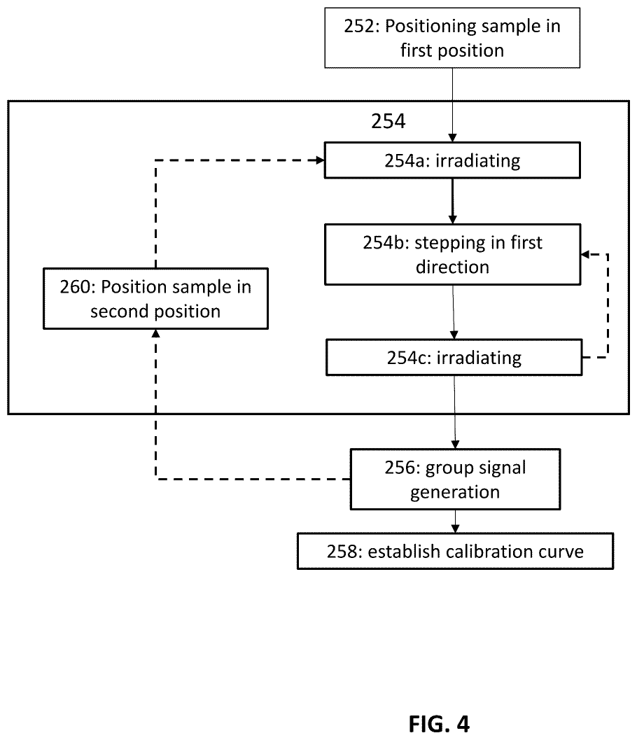

FIG. 4 is a flow diagram showing the steps of the calibration method for the gauging instrument 100, according to some implementations. In step 252, n samples 101 are positioned, one at a time, in the first position 204 between the source 102 and the detector array 106 of m detectors. In the next steps 254 the n samples 101 are individually scanned by: 254a irradiating each sample 101 with x-rays from the source 102 (FIG. 2); 254b stepping each sample 101 in the first direction 110 in a step that is smaller than the spatial resolution of the detectors 108; and 254c irradiating each sample 101 with x-rays from the source 102. The stepping 254b and irradiating 254c steps can be repeated. In step 256 the group of m signals are generated, where each signal is proportional to x-rays transmitted through each of the n samples 101 and impinging on one of the m detectors 108 during each step. In step 258, the calibrations curves for each of the detectors 108 are established.

In some implementations, for example prior to establishing the calibration curve, the n samples (or a subset of these) is positioned in the second position 304 (FIG. 3), step 260. The second position 304 is offset from the first position 204 in the second direction 112 that is perpendicular to the first direction 110. The second position 304 positions the n samples, one at a time, between the source and the detector array, where the sample 101 is the same distance from the source as in the first position. Steps 254a, 254b, 254 c are then repeated. A group of m′ signals is generated in step 256 (rather than m signals). The group of m′ signals are each proportional to x-rays transmitted through each of the n samples 101 during each step in the first direction starting from the second position. The group of m′ signals can then be used to update a calibration curve established in step 258, or the group of m′ signals and m signals are combined and then the calibration curve is established using the m and m′ signals.

In some implementations the sample 101 is flat and has a uniform profile. For example, in some implementations the sample 101 has a total thickness variation (TTV) of less than 10 microns (e.g., less than 5 microns, less than 3 microns, or less than 1 micron). In some implementations, the sample 101 varies by less than 5% from an average thickness of the sample 101.

In some implementations, the sample 101 also has a uniform composition. For example, the sample 101 can have a layered structure wherein each layer has the same composition, or the sample 101 can be substantially homogenous throughout. Here substantially homogeneous means that the bulk of the sample 101 has a homogeneous composition with the recognition that outer surfaces may have a thin layer (e.g., 1-100 nm) of a different material, such as an oxide. In some implementations, the sample 101 has less than about 100 ppm of impurities (e.g., less than 10 ppm, less than 1 ppm, less than 100 ppb, less than 10 ppb of impurities). The sample 101 can include any element or combination of elements that can be formed into a stable structure. As used here stable means the sample 101 holds its form and composition (i.e., it is not mechanically or chemically changed or degraded) during handling and irradiation with the gauging instrument 100. In some implementations, the sample 101 includes a metal or alloy. In some implementations, the sample 101 includes plastics such a polypropylene, polyethylene, polycarbonate, polyurethane. In some implementations the sample 101 includes main group elements such as carbon, silicon, germanium, oxygen, nitrogen and phosphorous. In some implementations, the sample 101 is a metal or main group oxide. The sample can even include a fluid within a container. In some implementations, the sample has a composition that is within 5% of a target or expected composition.

In some implementations, the sample 101 is a semiconductor wafer or a portion thereof, such as a coupon or cut out from the semiconductor wafer. In some implementations the semiconductor wafer includes group IV elements (e.g., carbon, silicon, germanium), II-V elements (e.g., aluminum, gallium, indium, arsenic, nitrogen, phosphorous), metals (e.g., copper, tungsten, titanium). For example, the semiconductor wafer can be a silicon wafer, a silicon nitride wafer, a silicon carbide wafer, a germanium wafer, a gallium arsenide wafer, a titanium nitride wafer, a tungsten wafer, a copper wafer, or a layered combination of these (e.g., a layer of silicon nitride, titanium nitride, copper or tungsten that is deposited or grown on silicon). In some implementations the semiconductor wafer is a silicon wafer. In some implementations the semiconductor wafer is a germanium wafer. In some implementations, the sample is a single crystal, such as grown by the Czochralski method. In some implementations, the wafer is a crystalline silicon wafer and in some other implementations the wafer is a crystalline germanium wafer.

In some implementations, the sample 101 includes battery electrode materials such as aluminum and copper sheets or foils. In some implementations, the sample 101 includes battery active materials such as metal oxides and metal phosphates. In some implementations, the sample 101 includes cathode active materials. In some implementations, the sample 101 is a coupon or cut out from a battery material, such as a cathode. In some implementations, the sample 101 includes a pure metal or a metal alloy. In some implementations, the sample 101 includes a plastic or a ceramic.

In some implementations, samples 101 having different basis weights or thickness are used. In some implementations, the samples 101 have different compositions. In some implementations, the samples 101 have the same compositions but different basis weights and thicknesses. The thickness of the sample 101 can be measured by any suitable profilometer, or a specification can be provided from the manufacturer. The basis weight can be determined by measuring an area of sample presented to the radiation 116 (e.g., a top portion of the sample generally facing the source 102) and weighing the sample, such as with an analytical balance: the basis weight is then calculated as the weight per area. In some implementations, the area of the sample facing the source is greater than about 10 cm², such as greater than 50 cm², or in a range of 10 to about 200 cm², such as 100 cm². In some implementations, the known basis weight of the sample 101 is determined to an accuracy of about 1%, 0.5% or 0.1%. In some implementations, the mass of the sample 101 is at least 5 mg (e.g., the sample has a mass between about 5 mg to 1000 g).

Any number of detectors 108 can be used in the detector array 106. For example, in some implementations, the number of the detectors 108 in the detector array 106 is between about 1 and 2000 (e.g., 10 to 2000).

Any suitable detectors 108 can be used. For example photodiodes that are sensitive to the radiation 116 can be used. The size of the diode can also be selected based on the resolution desired. In some implementations, the pitch of the diode can range from about 0.5 mm to about 1 cm, such as from about 1 mm to 1.6 mm.

In some implementations, the calibration curve is a polynomial least squares fit of the signals, or a value derived from the signals, and the corresponding basis weight or thickness of the samples 101. The dark or bright data can also be included in the polynomial fit. The polynomial order is selected to not be greater than about n/2+1 to avoid over fitting. Therefore, the calibration curve provides a relationship, a polynomial equation, relating the signals to basis weight or thickness for each of the detectors 108.

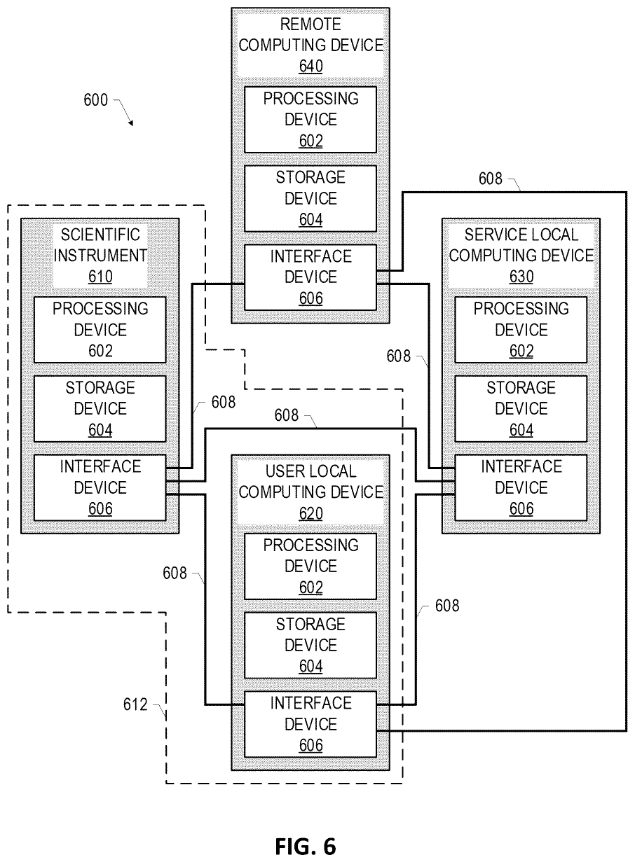

FIG. 5 is a block diagram of the computing device 500 that may perform some or all of the method steps described herein. In some implementations, the methods are implemented using a single computing device 500 or by multiple computing devices 500. Further, as discussed below, a computing device 500 (or multiple computing devices 500) that implements the methods may be part of one or more of the scientific instruments 610, the user local computing device 620, the service local computing device 630, or the remote computing device 640, described below with reference to FIG. 6.

The computing device 500 of FIG. 5 is illustrated as having a number of components, but any one or more of these components may be omitted or duplicated, as suitable for the application and setting. In some implementations, some or all of the components included in the computing device 500 may be attached to one or more motherboards and enclosed in a housing (e.g., including plastic, metal, and/or other materials). In some implementations, some these components may be fabricated onto a single system-on-a-chip (SoC) (e.g., an SoC may include one or more processing devices 502 and one or more storage devices 504). Additionally, in various implementations, the computing device 500 may not include one or more of the components illustrated in FIG. 5, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 500 may not include a display device 510, but may include display device interface circuitry (e.g., a connector and driver circuitry) to which a display device 510 may be coupled.

The computing device 500 may include a processing device 502 (e.g., one or more processing devices). As used herein, the term “processing device” may refer to any device or portion of a device that processes electronic data from registers and/or memory to transform that electronic data into other electronic data that may be stored in registers and/or memory. The processing device 502 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 500 may include a storage device 504 (e.g., one or more storage devices). The storage device 504 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some implementations, the storage device 504 may include memory that shares a die with a processing device 502. In such an embodiment, the memory may be used as cache memory and may include embedded dynamic random access memory (eDRAM) or spin transfer torque magnetic random access memory (STT-MRAM), for example. In some implementations, the storage device 504 may include non-transitory computer readable media having instructions thereon that, when executed by one or more processing devices (e.g., the processing device 502), cause the computing device 500 to perform any appropriate ones of or portions of the methods disclosed herein. The storage device 504 can also store the calibration curves for each of the detectors 108 as well as the signals generated by irradiating the samples 101 or object with radiation from the radiation source 102 and detecting radiation transmitted through the samples 101 or object and to the detectors 108.

The computing device 500 may include an interface device 506 (e.g., one or more interface devices 506). The interface device 506 may include one or more communication chips, connectors, and/or other hardware and software to govern communications between the computing device 500 and other computing devices. For example, the interface device 506 may include circuitry for managing wireless communications for the transfer of data to and from the computing device 500. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some implementations they might not. Circuitry included in the interface device 506 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some implementations, circuitry included in the interface device 706 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some implementations, circuitry included in the interface device 506 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some implementations, circuitry included in the interface device 506 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some implementations, the interface device 506 may include one or more antennas (e.g., one or more antenna arrays) to receipt and/or transmission of wireless communications.

In some implementations, the interface device 506 may include circuitry for managing wired communications, such as electrical, optical, or any other suitable communication protocols. For example, the interface device 506 may include circuitry to support communications in accordance with Ethernet technologies. In some implementations, the interface device 506 may support both wireless and wired communication, and/or may support multiple wired communication protocols and/or multiple wireless communication protocols. For example, a first set of circuitry of the interface device 506 may be dedicated to shorter-range wireless communications such as Wi-Fi or Bluetooth, and a second set of circuitry of the interface device 506 may be dedicated to longer-range wireless communications such as global positioning system (GPS), EDGE, GPRS, CDMA, WiMAX, LTE, EV-DO, or others. In some implementations, a first set of circuitry of the interface device 506 may be dedicated to wireless communications, and a second set of circuitry of the interface device 506 may be dedicated to wired communications.

In some implementations, the interface device can input the signals into the calibration curves or models for generating the calibration curves for each of the detectors 108, such as from the circuit 205.

The computing device 500 may include battery/power circuitry 508. The battery/power circuitry 508 may include one or more energy storage devices (e.g., batteries or capacitors) and/or circuitry for coupling components of the computing device 500 to an energy source separate from the computing device 500 (e.g., AC line power).

The computing device 500 may include a display device 510 (e.g., multiple display devices). The display device 510 may include any visual indicators, such as a heads-up display, a computer monitor, a projector, a touchscreen display, a liquid crystal display (LCD), a light-emitting diode display, or a flat panel display. In some implementations, the display device can show real time processing information such as thickness or basis weights across the web 104, or calibration curves for each of the detectors 108 while they are being established.

The computing device 500 may include other input/output (I/O) devices 512. The other I/O devices 512 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 500, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 500 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

One or more computing devices 500 implementing any of the methods disclosed herein may be part of a scientific instrument support system. FIG. 6 is a block diagram of an example scientific instrument support system 600 in which some or all the methods disclosed herein may be performed, in accordance with various implementations. The methods disclosed herein (e.g., the method describe with reference to FIGS. 2, 3 and 5) may be implemented by one or more of the scientific instruments 610 (e.g., the gauging or screening instrument 100), the user local computing device 620, the service local computing device 630, or the remote computing device 640 of the scientific instrument support system 600.

Any of the scientific instrument 610, the user local computing device 620, the service local computing device 630, or the remote computing device 640 may include any of the implementations of the computing device 500 discussed herein with reference to FIG. 5, and any of the scientific instrument 610, the user local computing device 620, the service local computing device 630, or the remote computing device 640 may take the form of any appropriate ones of the implementations of the computing device 500 discussed herein with reference to FIG. 5.

The scientific instrument 610, the user local computing device 620, the service local computing device 630, or the remote computing device 640 may each include a processing device 602, a storage device 604, and an interface device 606. The processing device 602 may take any suitable form, including the form of any of the processing devices 502 discussed herein with reference to FIG. 5, and the processing devices 602 included in different ones of the scientific instrument 610, the user local computing device 620, the service local computing device 630, or the remote computing device 640 may take the same form or different forms. The storage device 604 may take any suitable form, including the form of any of the storage devices 504 discussed herein with reference to FIG. 5, and the storage devices 604 included in different ones of the scientific instrument 610, the user local computing device 620, the service local computing device 630, or the remote computing device 640 may take the same form or different forms. The interface device 606 may take any suitable form, including the form of any of the interface devices 506 discussed herein with reference to FIG. 5, and the interface devices 606 included in different ones of the scientific instrument 610, the user local computing device 620, the service local computing device 630, or the remote computing device 640 may take the same form or different forms.

The scientific instrument 610, the user local computing device 620, the service local computing device 630, and the remote computing device 640 may be in communication with other elements of the scientific instrument support system 600 via communication pathways 608. The communication pathways 608 may communicatively couple the interface devices 606 of different ones of the elements of the scientific instrument support system 600, as shown, and may be wired or wireless communication pathways (e.g., in accordance with any of the communication techniques discussed herein with reference to the interface devices 506 of the computing device 500 of FIG. 5). The particular scientific instrument support system 600 depicted in FIG. 6 includes communication pathways between each pair of the scientific instrument 610, the user local computing device 620, the service local computing device 630, and the remote computing device 640, but this “fully connected” implementation is simply illustrative, and in various implementations, various ones of the communication pathways 608 may be absent. For example, in some implementations, a service local computing device 630 may not have a direct communication pathway 608 between its interface device 606 and the interface device 606 of the scientific instrument 610, but may instead communicate with the scientific instrument 610 via the communication pathway 608 between the service local computing device 630 and the user local computing device 620 and the communication pathway 608 between the user local computing device 620 and the scientific instrument 610.

The scientific instrument 610 may include any appropriate scientific instrument, such gauging or x-ray screening instruments 100.

The user local computing device 620 may be a computing device (e.g., in accordance with any of the implementations of the computing device 500 discussed herein) that is local to a user of the scientific instrument 610. In some implementations, the user local computing device 620 may also be local to the scientific instrument 610, but this need not be the case; for example, a user local computing device 620 that is in a user's home or office may be remote from, but in communication with, the scientific instrument 610 so that the user may use the user local computing device 620 to control and/or access data from the scientific instrument 610. In some implementations, the user local computing device 620 may be a laptop, smartphone, or tablet device. In some implementations the user local computing device 620 may be a portable computing device.

The service local computing device 630 may be a computing device (e.g., in accordance with any of the implementations of the computing device 500 discussed herein) that is local to an entity that services the scientific instrument 610. For example, the service local computing device 630 may be local to a manufacturer of the scientific instrument 610, a local user of the scientific instrument 610, or to a third-party service company. In some implementations, the service local computing device 630 may communicate with the scientific instrument 610, the user local computing device 620, and/or the remote computing device 640 (e.g., via a direct communication pathway 608 or via multiple “indirect” communication pathways 608, as discussed above) to receive data regarding the operation of the scientific instrument 610, the user local computing device 620, and/or the remote computing device 640 (e.g., the results of self-tests of the scientific instrument 610, calibration coefficients used by the scientific instrument 610, the measurements of sensors, such as the detectors, associated with the scientific instrument 610, etc.). In some implementations, the service local computing device 630 may communicate with the scientific instrument 610, the user local computing device 620, and/or the remote computing device 640 (e.g., via a direct communication pathway 608 or via multiple “indirect” communication pathways 608, as discussed above) to transmit data to the scientific instrument 610, the user local computing device 620, and/or the remote computing device 640 (e.g., to update programmed instructions, such as firmware, in the scientific instrument 610, to initiate the performance of test or calibration sequences in the scientific instrument 610, to update programmed instructions, such as software, in the user local computing device 620 or the remote computing device 640, etc.). A user of the scientific instrument 610 may utilize the scientific instrument 610 or the user local computing device 620 to communicate with the service local computing device 630 to report a problem with the scientific instrument 610 or the user local computing device 620, to request a visit from a technician to improve the operation of the scientific instrument 610, to order consumables or replacement parts associated with the scientific instrument 610, or for other purposes.

The remote computing device 640 may be a computing device (e.g., in accordance with any of the implementations of the computing device 500 discussed herein) that is remote from the scientific instrument 610 and/or from the user local computing device 620. In some implementations, the remote computing device 640 may be included in a datacenter or other large-scale server environment. In some implementations, the remote computing device 640 may include network-attached storage (e.g., as part of the storage device 604). The remote computing device 640 may store data generated by the scientific instrument 610, perform analyses of the data generated by the scientific instrument 610 (e.g., in accordance with programmed instructions), facilitate communication between the user local computing device 620 and the scientific instrument 610, and/or facilitate communication between the service local computing device 630 and the scientific instrument 610.

In some implementations, one or more of the elements of the scientific instrument support system 600 illustrated in FIG. 6 may not be present. Further, in some implementations, multiple ones of various ones of the elements of the scientific instrument support system 600 of FIG. 6 may be present. For example, a scientific instrument support system 600 may include multiple user local computing devices 620 (e.g., different user local computing devices 620 associated with different users or in different locations). In another example, a scientific instrument support system 600 may include multiple scientific instruments 610, all in communication with service local computing device 630 and/or a remote computing device 640; in such an embodiment, the service local computing device 630 may monitor these multiple scientific instruments 610, and the service local computing device 630 may cause updates or other information may be “broadcast” to multiple scientific instruments 610 at the same time. Different ones of the scientific instruments 610 in a scientific instrument support system 600 may be located close to one another (e.g., in the same room) or farther from one another (e.g., on different floors of a building, in different buildings, in different cities, etc.). In some implementations, a scientific instrument 610 may be connected to an Internet-of-Things (IoT) stack that allows for command and control of the scientific instrument 610 through a web-based application, a virtual or augmented reality application, a mobile application, and/or a desktop application. Any of these applications may be accessed by a user operating the user local computing device 620 in communication with the scientific instrument 610 by the intervening remote computing device 640. In some implementations, a scientific instrument 610 may be sold by the manufacturer along with one or more associated user local computing devices 620 as part of a local scientific instrument computing unit 612.

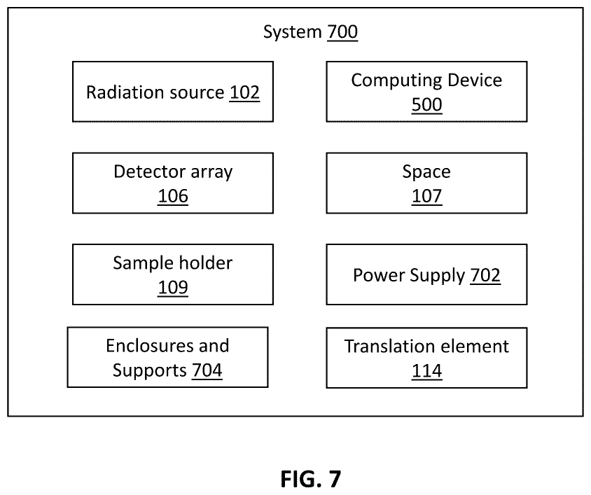

FIG. 7 is a block diagram of a system 700 for checking a gauge response, according to some implementations. The system includes elements that have previously been described: the radiation source 102, the detector array 106 linearly arranged or oriented in the first direction 110, the sample holder 109, the computing device 500, and the space 107 between the source 102 and the detector array 106. The system also includes a power supply 702 such as a mains power supply or a battery. The power supply 702 can be the same as the battery/power 508 that powers the computing device 500, or the power supply 702 can be a different power supply. In some implementations, the system 700 also includes the translation element 114, such as rollers to translate the web 104 through the space 107.

In some implementations, the system also includes one or more enclosures and supports 704. The one or more supports hold or support the various components so they can function. For example, a supporting frame can hold the source 102 in the correct orientation above the detector array 106 (FIG. 2). The supports can also hold mechanical elements such as motors that are connected to the sample holder 109 or the translation element 114. Enclosures can be implemented for safety. For example, radiation shielding can be included as part of the enclosures. Enclosures can also be used to partition various elements of the system such as the gauging instrument 100 and the computing device 500.

The gauging instrument 100 can be an instrument used to screen or gauge an object. Without limitation, the object can be a continuous film, or individual objects such as parcels, freight, mail, and minerals on a conveyor belt or similar transporting system. In some implementations, the object is a foodstuff or a pharmaceutical. In some implementations the object is an organism such as a plant or mammal. In some implementations, the object is a vehicle such as a car, train, or truck. In some implementations, the object is a cathode or anode of a lithium-ion battery, or a precursor of these. In some implementations, the object is the separator for a lithium-ion battery.

The following numbered paragraphs 1-15 provide various examples of the embodiments disclosed herein.

Paragraph 1. A calibration method for a gauging instrument (100), the method comprising: positioning in a first position (204), and one at a time, n samples (101) each having a known basis weight, said first position (204) is between a source (102) and a detector array (106) comprised of m detectors (108) linearly oriented in a first direction (110); scanning the n samples (101) by, (a) irradiating each of the n samples (101) with x-rays from the source (102), (b) stepping each of the n samples (101) in the first direction (110) in a step that is smaller than the spatial resolution of the detectors (108), and (c) irradiating each of the n samples (101) with x-rays from the source (102); generating m groups of signals, each group corresponding to one of the m detectors 108, and each signal proportional to x-rays transmitted through each of the n samples (101) and impinging on one of the m detectors (108) during the scanning; and establishing a calibration curve for each detector (108) by fitting the known basis weights for each of the n samples (101) to the group of m signals, wherein n is a positive integer greater than 0 and m is positive integer greater than 1.

Paragraph 2. The method according to paragraph 1 further comprising repeating the (b) stepping and (c) irradiating steps one or more times.

Paragraph 3. The method according to paragraph 1 or paragraph 2, wherein the samples (101) are flat.

Paragraph 4. The method according to any of paragraphs 1 to 3, wherein the samples (101) each independently have a uniform composition.

Paragraph 5. The method according any of paragraphs 1-4, wherein the samples (101) include cathode active materials, a pure metal, a metal alloy, a plastic, ceramic, or a semiconductor material.

Paragraph 6. The method according to any of paragraphs 1-5, wherein the known basis weight is accurate to 1%.

Paragraph 7. The method according to any of paragraphs 1-6, wherein an area of the sample (101) facing the source is greater than 10 cm².

Paragraph 8. The method according to any of paragraphs 1-7, wherein the mass of the sample (101) is at least 5 mg.

Paragraph 9. The method according to any of paragraphs 1-8, wherein the number of n samples (101) is greater than 1.

Paragraph 10. The method according to any of paragraphs 1-9, wherein the number of detectors (108) in the array m is between 1 and 20000.

Paragraph 11. The method according to any of paragraphs 1-10, wherein prior to establishing the calibration curve: positioning in a second position (304), and one at a time, the n samples between the source (102) and the detector array (106), wherein the second position (304) is offset in a second direction (112) that is perpendicular to the first direction (110) and the second position (304) places the n samples (101) the same distance from the source (102) as in the first position (204); scanning the n samples (101) by repeating steps (a), (b) and (c); generating a group of m′ signals each proportional to x-rays transmitted through each of the n samples (101) during each step and impinging on one of the m detectors (108) during each step; and updating the group of m signals to include the group of m′ signals prior to establishing the calibration curve for each detector (108).

Paragraph 12. The method according to any of paragraphs 1-11, wherein the step is less than or equal to half of the spatial resolution of the n detectors.

Paragraph 13. The method according to any of paragraphs 1-12, wherein the step is less than or equal to 5 mm.

Paragraph 14. The method according to any of paragraphs 1-13 further comprising stopping after each step for the same amount of time.

Paragraph 15. The method according to any of paragraphs 1-14, wherein the x-rays from the source (102) form a fan-beam emanating from the source (102) and expanding towards the array of detectors (106).

Paragraph 16. The method according to any of paragraphs 1-15, wherein the n samples (101) are positioned proximate to the detector array (106) and distal from the source (102).

Paragraph 17. A system for calibration of a gauging instrument (100) comprising: an x-ray source (102); a detector array (106) comprised of m detectors (108) linearly oriented in a first direction (110); a space (107) between the source (102) and the detector array (106); a sample holder (109); and a computing device (500) having executable code stored thereon, wherein the executable code is configured to send instruction for one or more of: positioning in a first position (204), and one at a time, n samples (101) each having a known basis weight, said first position (204) is between a source (102) and a detector array (106) comprised of m detectors (108) linearly oriented in a first direction (110); scanning the n samples (101) by, (a) irradiating each of the n samples (101) with x-rays from the source (102), (b) stepping each of the n samples (101) in the first direction (110) in a step that is smaller than the spatial resolution of the detectors (108), and (c) irradiating each of the n samples (101) with x-rays from the source (102); generating m groups of signals, each group corresponding to one of the m detectors 108, and each signal proportional to x-rays transmitted through each of the n samples (101) and impinging on one of the m detectors (108) during the scanning; and establishing a calibration curve for each detector (108) by fitting the known basis weights for each of the n samples (101) to the group of m signals, wherein n is a positive integer greater than 0 and m is positive integer greater than 1.

Paragraph 18. The system according to paragraph 17, wherein the sample holder (109) can accommodate more than one sample (101) at a time.

Paragraph 19. The system according to paragraph 17 or paragraph 18, wherein the step is less than the spatial resolution of the n detectors (108).

Paragraph 20. The system according to any of paragraphs 17-19, wherein the sample holder (109) is an xy-stage that can move the sample (101) in a second direction (112) perpendicular to the first direction while maintaining the same distance of the sample (101) to the source (102).Paragraph 21. The system according to paragraph 20 further comprising: a translation element configured to translate an object through or in the space in a second direction that is different from the first direction.

Paragraph 22. One or more non-transitory computer readable media having instructions thereon that, when executed by one or more processing devices of a gauging instrument support apparatus, cause the gauging support apparatus to perform the method of any one of paragraphs 1-16.

Those having skill in the art, with the knowledge gained from the present disclosure, will recognize that various changes can be made to the disclosed apparatuses and methods in attaining these and other advantages, without departing from the scope of the present disclosure. As such, it should be understood that the features described herein are susceptible to modification, alteration, changes, or substitution. For example, it is expressly intended that all combinations of those elements and/or steps which perform substantially the same function, in substantially the same way, to achieve the same results are within the scope of the embodiments described herein. Substitutions of elements from one described embodiment to another are also fully intended and contemplated. The specific embodiments illustrated and described herein are for illustrative purposes only, and not limiting of that which is set forth in the appended claims. Other embodiments will be evident to those of skill in the art. It should be understood that the foregoing description is provided for clarity only and is merely exemplary. The spirit and scope of the present disclosure is not limited to the above implementation and examples but is encompassed by the following claims. All publications and patent applications cited above are incorporated by reference in their entirety for all purposes to the same extent as if each individual publication or patent application were specifically and individually indicated to be so incorporated by reference.

What is claimed is:

1. A calibration method for a gauging instrument (100), the method comprising:
positioning in a first position (204), and one at a time, n samples (101) each having a known basis weight, said first position (204) is between a source (102) and a detector array (106) comprised of m detectors (108) linearly oriented in a first direction (110);
scanning the n samples (101) by,
(a) irradiating each of the n samples (101) with x-rays from the source (102),
(b) stepping each of the n samples (101) in the first direction (110) in a step that is smaller than the spatial resolution of the detectors (108), and
(c) irradiating each of the n samples (101) with x-rays from the source (102);
generating m groups of signals, each group corresponding to one of the m detectors 108, and each signal proportional to x-rays transmitted through each of the n samples (101) and impinging on one of the m detectors (108) during the scanning; and
establishing a calibration curve for each detector (108) by fitting the known basis weights for each of the n samples (101) to the group of m signals,
wherein n is a positive integer greater than 0 and m is a positive integer greater than 1.

2. The method according to claim 1 further comprising repeating the (b) stepping and (c) irradiating steps one or more times.

3. The method according to claim 1, wherein the samples (101) are flat.

4. The method according to claim 1, wherein the samples (101) each independently have a uniform composition.

5. The method according to claim 1, wherein the samples (101) include cathode active materials, a pure metal, a metal alloy, a plastic, ceramic, or a semiconductor material.

6. The method according to claim 1, wherein the known basis weight is accurate to 1%.

7. The method according to claim 1, wherein an area of the sample (101) facing the source is greater than 10 cm².

8. The method according to claim 1, wherein a mass of the sample (101) is at least 5 mg.

9. The method according to claim 1, wherein a number of n samples (101) is greater than 1.

10. The method according to claim 1, wherein a number of detectors (108) in the array m is between 1 and 20000.

11. The method according to claim 1, wherein prior to establishing the calibration curve:
positioning in a second position (304), and one at a time, the n samples between the source (102) and the detector array (106), wherein the second position (304) is offset in a second direction (112) that is perpendicular to the first direction (110) and the second position (304) places the n samples (101) a same distance from the source (102) as in the first position (204);
scanning the n samples (101) by repeating steps (a), (b) and (c);
generating a group of m′ signals each proportional to x-rays transmitted through each of the n samples (101) during each step and impinging on one of the m detectors (108) during each step; and
updating the group of m signals to include the group of m′ signals prior to establishing the calibration curve for each detector (108).

12. The method according to claim 1, wherein the step is less than or equal to half of a spatial resolution of the n detectors.

13. The method according to claim 1, wherein the step is less than or equal to 5 mm.

14. The method according to claim 1 further comprising stopping after each step for the same amount of time.

15. The method according to claim 1, wherein x-rays from the source (102) form a fan-beam emanating from the source (102) and expanding towards the array of detectors (106).

16. The method according to claim 1, wherein the n samples (101) are positioned proximate to the detector array (106) and distal from the source (102).

17. A system for calibration of a gauging instrument (100) comprising:
an x-ray source (102);
a detector array (106) comprised of m detectors (108) linearly oriented in a first direction (110);
a space (107) between the source (102) and the detector array (106);
a sample holder (109); and
a computing device (500) having executable code stored thereon, wherein the executable code is configured to send instruction for one or more of:
positioning in a first position (204), and one at a time, n samples (101) each having a known basis weight, said first position (204) is between a source (102) and the detector array (106);
scanning the n samples (101) by,
(a) irradiating each of the n samples (101) with x-rays from the source (102),
(b) stepping each of the n samples (101) in the first direction (110) in a step that is smaller than the spatial resolution of the detectors (108), and
(c) irradiating each of the n samples (101) with x-rays from the source (102);
generating m groups of signals, each group corresponding to one of the m detectors 108, and each signal proportional to x-rays transmitted through each of the n samples (101) and impinging on one of the m detectors (108) during the scanning; and
establishing a calibration curve for each detector (108) by fitting the known basis weights for each of the n samples (101) to the group of m signals,
wherein n is a positive integer greater than 0 and m is positive integer greater than 1.

18. The system according to claim 17, wherein the sample holder (109) can accommodate more than one sample (101) at a time.

19. The system according to claim 17, wherein the step is less than the spatial resolution of the n detectors (108).

20. The system according to claim 17, wherein the sample holder (109) is an xy-stage that can move the sample (101) in a second direction (112) perpendicular to the first direction while maintaining the same distance of the sample (101) to the source (102).

21. The system according to claim 17 further comprising a translation element (114) configured to translate a web (104) through the space (107).

22. One or more non-transitory computer readable media having instructions thereon that, when executed by one or more processing devices of a gauging instrument support apparatus, cause the gauging support apparatus to perform the method of claim 1.
